(19) United States
(12) Patent Application Publication
(10) Pub. No.: US 2013/0057236 A1
(43) Pub. Date: Mar. 7, 2013

(54) LOW VOLTAGE RIDE-THROUGH CONTROL METHOD FOR GRID-CONNECTED CONVERTER OF DISTRIBUTED ENERGY RESOURCES

(71) Applicants: Che-Wei HSU, Pingtung County (TW); Chia-Tse LEE, Tainan City (TW); Po-Tai CHENG, Hsinchu City (TW)

(72) Inventors: Che-Wei HSU, Pingtung County (TW); Chia-Tse LEE, Tainan City (TW); Po-Tai CHENG, Hsinchu City (TW)

(21) Appl. No.: 13/225,967

(22) Filed: Sep. 6, 2011

(51) Int. Cl. G05F 1/00

(52) U.S. Cl. 323/268

(57) ABSTRACT

An LVRT control method for a grid-connected converter of distributed energy resources comprises steps of: obtain a positive sequence electrical component and a negative sequence electrical component during an LVRT period; outputting a compensation signal according to a power threshold withstood by a grid-connected converter to undertake reactive power compensation; and constraining the output power lower than the power threshold. The present invention uses the positive and negative sequence electrical components to undertake reactive power compensation, whereby to improve balance and stability of voltage during the LVRT period, avoid reverse torque and mechanical resonance, and prolong the service life of the power generator. Moreover, the present invention constrains the sum of the compensation currents below the power threshold to prevent the circuit of the power generator from being overloaded and damaged, whereby is prolonged the service life of the power system.

### FIELD OF THE INVENTION

The present invention relates to a low voltage ride-through control method, particularly to a low voltage ride-through control method for a grid-connected converter of distributed energy resources.

### BACKGROUND OF THE INVENTION

With advance of renewable energy technology, the conventional centralized power generation technology has been gradually replaced by distributed power generation technology. The distributed power generation system can sustain an area with sufficient power generation, and its efficiency, stability and reliability also have been greatly promoted with maturity of technology. Moreover, the distributed power generation system has advantages of smaller volume and lower environmental impact. Therefore, the distributed power generation technology has been the trend of power generation.

The energy resources of the distributed power generation system include solar cells, fuel cells, wind power, etc. The distributed power generation system may operate in two modes: the independent mode and the grid-connection mode. The former is mainly applied to an area where a large-scale power network cannot reach. The latter is applied to an area in the power network, in which loads increase fast. Herein, the grid-connected wind power generation system is used to exemplify the distributed power generation technology. The wind power generation system is demanded to supply stable power. The wind power generation system is utilized more and more popular and has higher and higher proportion in the overall power generation systems. When a ground fault causes voltage sag or outage, the wind power generation system still supplies stable voltage output within a given period of time, which is called the low voltage ride-through (LVRT) technology, wherein the power system would not instantly disconnect from the power network but undertakes active and reactive power currents or voltage compensation to avoid damage to the loads and unnecessary waiting or warming-up time for resuming supplying power from outage, wherefore stable voltage may be resumed faster.

Generally, alternating current consists of positive sequence voltage and negative sequence voltage each having three phases. When voltage drops abruptly, phase imbalance takes place and needs compensation to achieve balance. A US publication No. 2007/0177314 entitled “Method, Apparatus, and Computer Program Product for Injection Current” discloses a method including steps as follows: 1. tracking the negative sequence component and the positive sequence component of the electrical signal; 2. determining the value of the negative sequence component via detecting at least a portion of magnetic field; 3. undertaking modification or compensation via injecting the negative sequence component, whereby the positive and negative sequence components are compensated to achieve balance. However, if the compensation component is too large, the voltage and current components may exceed the threshold that the circuit system can bear and damage the circuit. Salvador Alepuz, et al. proposed a paper of “Control Strategies Based on Symmetrical Components for Grid-Connected Converters under Voltage Dips” in IEEE Transactions on Industrial Electronics, Vol. 56, No. 6, June 2009. Fainan A. Magueed, et al. proposed a paper of “Transient Performance of Voltage Source Converter under Unbalanced Voltage Dips” in 35th Annual IEEE Power Electronics Specialists Conference, 2004. Both papers mentioned using current with the negative sequence component to undertake compensation to obtain stability and balance of the output voltage. However, the two papers neither can solve the problem of damaging the circuit when the compensation current exceeds the threshold.

### SUMMARY OF THE INVENTION

The primary objective of the present invention is to solve the problem of damaging the circuit when the compensation current exceeds the threshold.

Another objective of the present invention is to solve the problem that voltage is unstable in the LVRT period in the conventional technology.

To achieve the above-mentioned objectives, the present invention proposes a low voltage ride-through (LVRT) control method for a grid-connected converter of distributed energy resources, wherein a grid-connected converter connects with a power generation unit and supplies power to a power network connecting with the grid-connected converter. The control method of the present invention comprises the following steps:

Step S1: receiving an output power, and using a processor to capture the output power to obtain a positive sequence electrical component and a negative sequence electrical component during abnormal power drop;

Step S2: calculating a compensation signal, wherein the processor works out a negative sequence reactive power compensation signal according to the positive sequence electrical component, the negative sequence electrical component and a power threshold withstood by the grid-connected converter, and outputs the negative sequence reactive power compensation signal to a regulation unit controlling the grid-connected converter;

Step S3: undertaking signal compensation, wherein the regulation unit undertakes reactive power compensation for the negative sequence electrical component output by the grid-connected converter according to the negative sequence reactive power compensation signal, and lets the sum of the positive sequence electrical component and the compensated negative sequence electrical component not higher than the power threshold.

The present invention improves balance and stability of voltage in the LVRT period via using the negative sequence electrical component to perform the reactive power compensation, whereby are avoided reverse torque and mechanical resonance, and whereby is prolonged the service life of the power generator. Further, the present invention controls the sum of all the compensation currents below the power threshold to prevent the circuit of the power generator from being overloaded and damaged, whereby is increased the service life of the power system.

### BRIEF DESCRIPTION OF THE DRAWINGS

FIG. 1 is a diagram schematically showing a circuit according to one embodiment of the present invention;

FIG. 2 is a flowchart of a control method according to one embodiment of the present invention;

FIG. 3 is a diagram schematically showing the output curves at different phase angles according to one embodiment of the present invention;

FIG. 4A is a diagram schematically showing three-phase output currents according to one embodiment of the present invention;

FIG. 4B is a diagram schematically showing three-phase output currents in an LVRT period according to one embodiment of the present invention; and

FIG. 5 is a diagram schematically showing a low-ripple selection line according to one embodiment of the present invention.

### DETAILED DESCRIPTION OF THE PREFERRED EMBODIMENTS

The technical contents are described in detail in cooperation with the drawings below.

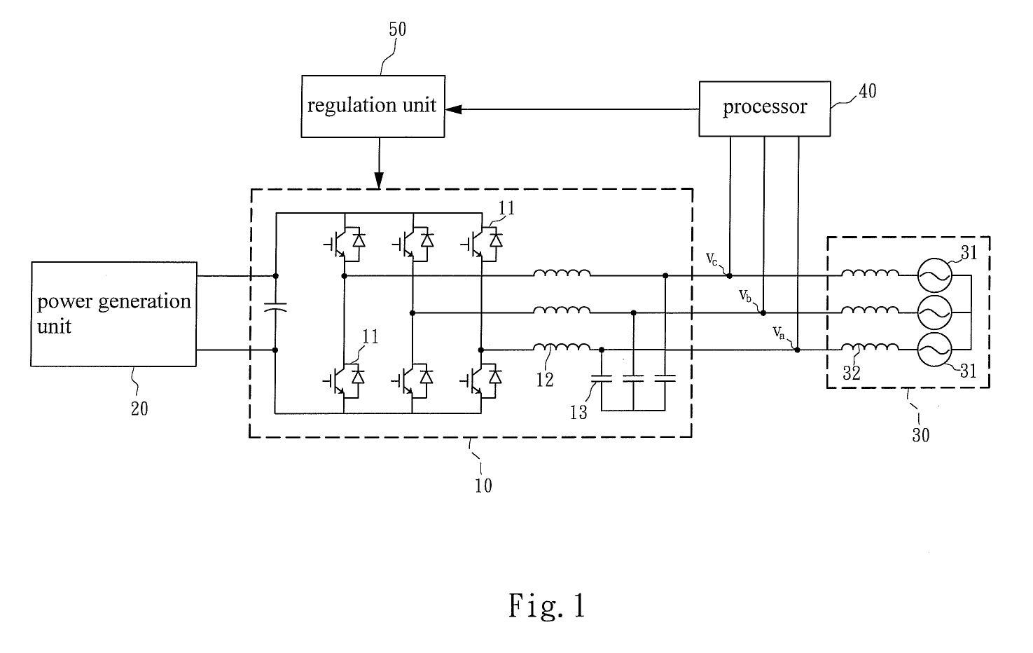

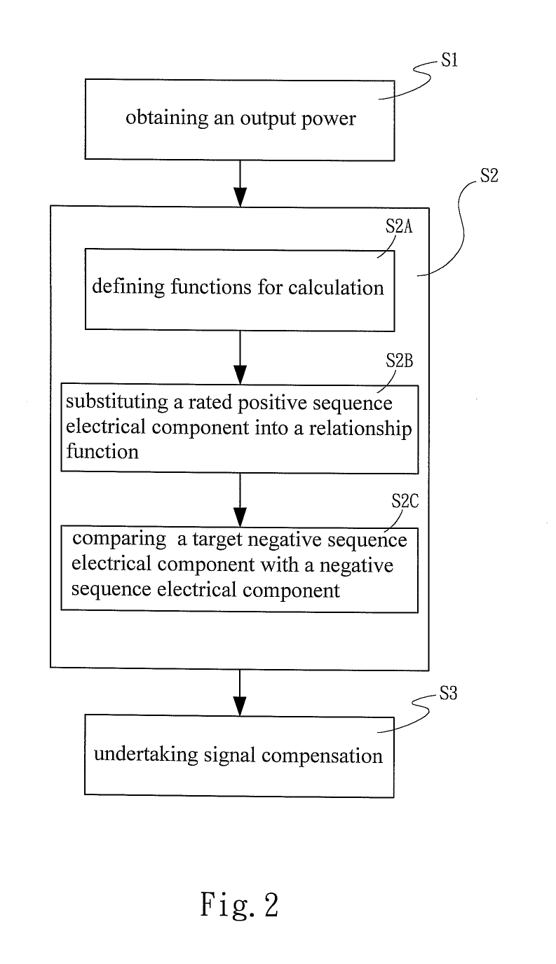

Refer to FIG. 1 and FIG. 2. The present invention discloses a low voltage ride-through (LVRT) control method for a grid-connected converter of distributed energy resources, wherein a grid-connected converter 10 connects with a power generation unit 20 and supplies power to a power network 30 connected with the grid-connected converter 10. The control method of the present invention comprises the following steps.

Step S1: receiving an output power, and using a processor 40 to capture the output power to obtain a positive sequence electrical component and a negative sequence electrical component during abnormal power drop, wherein the positive sequence electrical component includes a positive sequence active power current and a positive sequence reactive power current, and wherein the negative sequence electrical component includes a negative sequence reactive power current.

Step S2: calculating the compensation signal, wherein the processor 40 works out a negative sequence reactive power compensation signal according to the positive sequence electrical component, the negative sequence electrical component and a power threshold withstood by the grid-connected converter 10, and outputs the negative sequence reactive power compensation signal to a regulation unit 50 controlling the grid-connected converter 10. In one embodiment, the power threshold is determined by an upper power limit withstood by an IGBT 11 (Insulated Gate Bipolar Transistor) arranged inside the grid-connected converter 10. A plurality of inductors 12 electrically connect with a plurality of IGBT's 11. The grid-connected converter 10 also includes a plurality of capacitors 13 electrically connecting with the inductors 12. The power network 30 includes a plurality of inductors 32 electrically connecting with the grid-connected converter 10 and a plurality of AC signal sources 31 connecting with the inductors 32. In LVRT technology, the first priority is normally to compensate the active power; if there is extra output, the reactive power compensation is then undertaken. Therefore, the positive sequence compensation signal is manipulated to compensate the positive sequence active power and the positive sequence reactive power according to the requirement for the active power in the LVRT conditions. Besides, the negative sequence electrical component does not influence the active power and is thus not taken into calculation. After the positive sequence electrical component is defined, the calculation of the compensation signal of the negative sequence electrical component is then undertaken. Step S2 further includes the following steps to calculate compensation signals.

Step S2A: defining functions for calculation. Since the positive sequence compensation has been determined, the value of the negative sequence compensation has to be worked out next. Before the negative sequence compensation is calculated, a first function correlating with the positive sequence electrical component and a second function correlating with the negative sequence electrical component have to be defined first to then obtain a relationship function of the power threshold and the first and second functions. Normally, an AC signal contains three phase voltage components vₐ, v_{b} and v_{c} having different phases and expressed by

$${v}_{a} = {V}_{p} cos ( ω t + {θ}_{1} ) + {V}_{n} cos ( - ω t - {θ}_{2} )$$

$${v}_{b} = {V}_{p} cos ( ω t - \frac{2}{3} π + {θ}_{1} ) + {V}_{n} cos ( - ω t - \frac{2}{3} π - {θ}_{2} )$$

$${v}_{c} = {V}_{p} cos ( ω t + \frac{2}{3} π + {θ}_{1} ) + {V}_{n} cos ( - ω t + \frac{2}{3} π - {θ}_{2} )$$

Each of the three phase voltage components contains the first function correlating with the positive sequence electrical component and the second function correlating with the negative sequence electrical component. For example, vₐ is equal to the sum of the first function (the antecedent) and the second function (the consequent). Similarly, v_{b} and v_{c} also contain the first function and the second function. The first functions and the second functions of vₐ, v_{b} and v_{c} have respectively a phase difference of 120 degrees. The AC signal also contains three phase current components iₐ, i_{b} and i_{c} having different phases and expressed by

$${i}_{a} = {I}_{p} cos ( ω t + {θ}_{1} + {θ}_{p} ) + {I}_{n} cos ( - ω t - {θ}_{2} + {θ}_{n} )$$

$${i}_{b} = {I}_{p} cos ( ω t - \frac{2}{3} π + {θ}_{1} + {θ}_{p} ) + {I}_{n} cos ( - ω t - \frac{2}{3} π - {θ}_{2} + {θ}_{n} )$$

$${i}_{c} = {I}_{p} cos ( ω t + \frac{2}{3} π + {θ}_{1} + {θ}_{p} ) + {I}_{n} cos ( - ω t + \frac{2}{3} π - {θ}_{2} + {θ}_{n} )$$

Each of the three phase current components also contains a first function correlating with the positive sequence electrical component and a second function correlating with the negative sequence electrical component.

Vₚ and Iₚ are the positive sequence electrical components; Vₙ and Iₙ are the negative sequence electrical components. θ₁ and θ₂ are respectively the phase angles of the positive sequence voltage and the negative sequence voltage; θₚ and θₙ are respectively the phase angles of the positive sequence current and the negative sequence current. The positive sequence electrical component includes the positive sequence active power current and the positive sequence reactive power current to compensate the positive sequence active power and the positive sequence reactive power. The negative sequence electrical component includes the negative sequence reactive power current to compensate the negative sequence reactive power. In one embodiment, the signal is regulated via current compensation. The peak value of the current is thus the power threshold Iₘₐₓ and is expressed by

$${I}_{a ( peak )} = \sqrt{{I}_{p}^{2} + {I}_{n}^{2} + 2 {I}_{p} {I}_{n} cos α}$$

$${I}_{b ( peak )} = \sqrt{{I}_{p}^{2} + {I}_{n}^{2} + 2 {I}_{p} {I}_{n} cos ( α + \frac{4}{3} π )}$$

$${I}_{c ( peak )} = \sqrt{{I}_{p}^{2} + {I}_{n}^{2} + 2 {I}_{p} {I}_{n} cos ( α - \frac{4}{3} π )}$$

$$α = {θ}_{2} - {θ}_{1} - π$$

Then, the relationship function of the power threshold Iₘₐₓ and the first and second functions is obtained from the following equations:

Iₘₐₓ=max(Iₐ₍ₚₑₐₖ₎,I_{b(peak)},I_{c(peak)})

Iₘₐₓ≧\sqrt{2}I_{rated}

wherein I_{rated} is RMS (Root Mean Square) of the output signal of the grid-connected converter 10 and used to calculate the effective value of the power output.

The power threshold Iₘₐₓ must be greater than the peak value of the current compensation lest the circuit is burned down. The power threshold Iₘₐₓ is settled down after circuit design is completed. The peak value of the current compensation must be constrained to be lower than the power threshold Iₘₐₓ to prevent the circuit from being burned down.

Step S2B: substituting a rated positive sequence electrical component into the relationship function, and using the power threshold to obtain a target negative sequence electrical component. The rated positive sequence electrical component is a value should be compensated according to power company or power system regulation. When voltage drops abruptly and the positive sequence active power decreases greatly, a positive sequence compensation signal is output to compensate the positive sequence active power and the positive sequence reactive power according to the rated positive sequence electrical component. As to the negative sequence compensation, the relationship of the power threshold Iₘₐₓ to the positive and negative sequence currents are obtained from the equations mentioned above. Then, the theoretical negative sequence current Iₙₜ is obtained from the positive sequence current component Iₚ and the power threshold Iₘₐₓ according to the following equation:

$${I}_{nt} = - {I}_{p} cos ( α + \frac{4}{3} k π ) + \sqrt{{I}_{p}^{2} [ {cos}^{2} ( α + \frac{4}{3} k π ) - 1 ] + {I}_{max}^{2}}$$

$$\{ \begin{matrix}k = 0 , & - \frac{π}{3} \leq α < \frac{π}{3} \\ k = 1 , & \frac{1}{3} π \leq α < π \\ k = - 1 , & π \leq α < \frac{5}{3} π\end{matrix}$$

It should be explained herein that the AC signal has a sinusoidal waveform whose phase varies with time. The waveform is slightly different at different phase angles. Therefore, the k value also varies at different phase angles.

Step S2C: comparing the target negative sequence electrical component with the negative sequence electrical component to obtain the negative sequence reactive power compensation signal to undertake the signal compensation. There may be a difference existing between the practical negative sequence electrical component Iₙ and the theoretical negative sequence current Iₙₜ. The negative sequence reactive power compensation signal that is required to be compensated can be obtained from the difference.

Step S3: undertaking the signal compensation. According to the positive sequence compensation signal and the negative sequence reactive power compensation signal, the regulation unit 50 regulates the positive sequence electrical component and the negative sequence electrical component output by the grid-connected converter 10 to compensate the positive sequence active and reactive powers and the negative sequence reactive power, and lets the sum of the compensated positive sequence electrical component and the compensated negative sequence electrical component not higher than the power threshold. More specially, the regulation unit 50 regulates the output power via controlling the IGBT 11 inside the grid-connected converter 10.

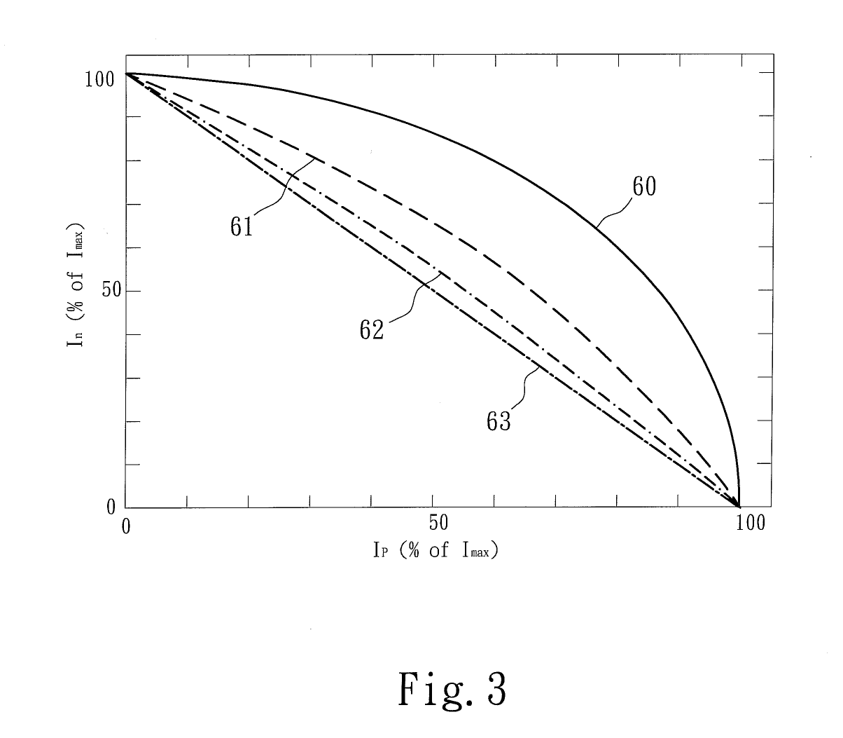

Refer to FIG. 3 a diagram schematically showing the output curves at three different phase angles, wherein the Y-coordinate and X-coordinate respectively denote the percentages of the negative sequence current and the positive sequence current to the power threshold, and

wherein Curve 61 is the output curve of a first phase angle, and

$$α = \pm \frac{π}{3} - \frac{4}{3} k π , k = 0 , \pm 1 ,$$

and
wherein Curve 62 is the output curve of a second phase angle, and

$$α = \pm \frac{π}{6} - \frac{4}{3} k π , k = 0 , \pm 1 ,$$

and
wherein Curve 63 is the output curve of a third phase angle, and

$$α = - \frac{4}{3} k π , k = 0 , \pm 1.$$

Comparing with the Curve 60 of the power threshold, the Curves 61, 62 and 63 of the first, second and third phase angles would not approximate to the Curve 60 of the power threshold unless the positive sequence current or the negative sequence current equals the power threshold. Therefore, the output curve would not exceed the Curve 60 of the power threshold no matter how the positive sequence current or the negative sequence current is regulated.

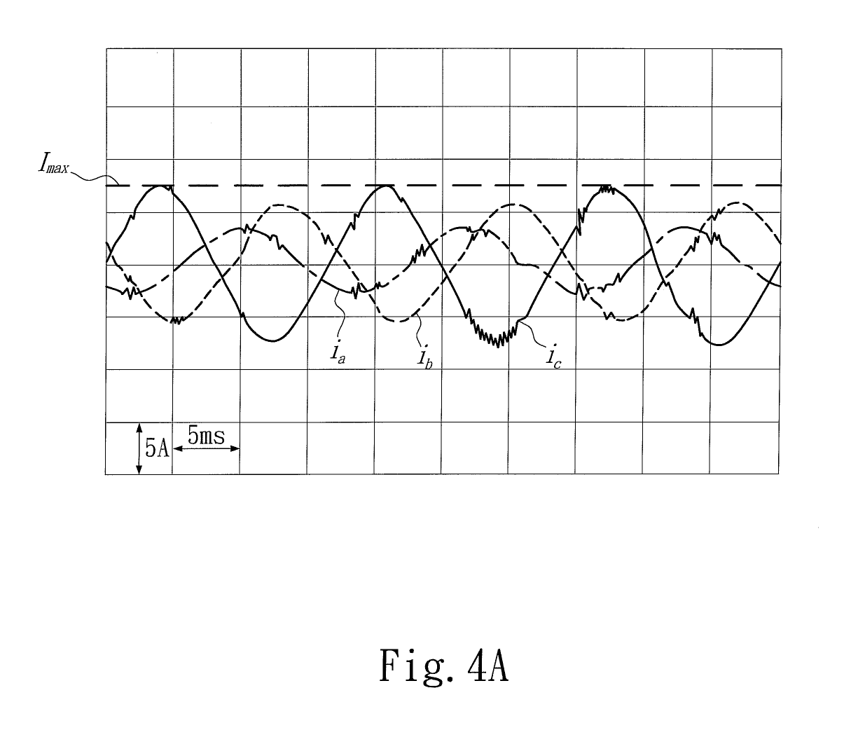

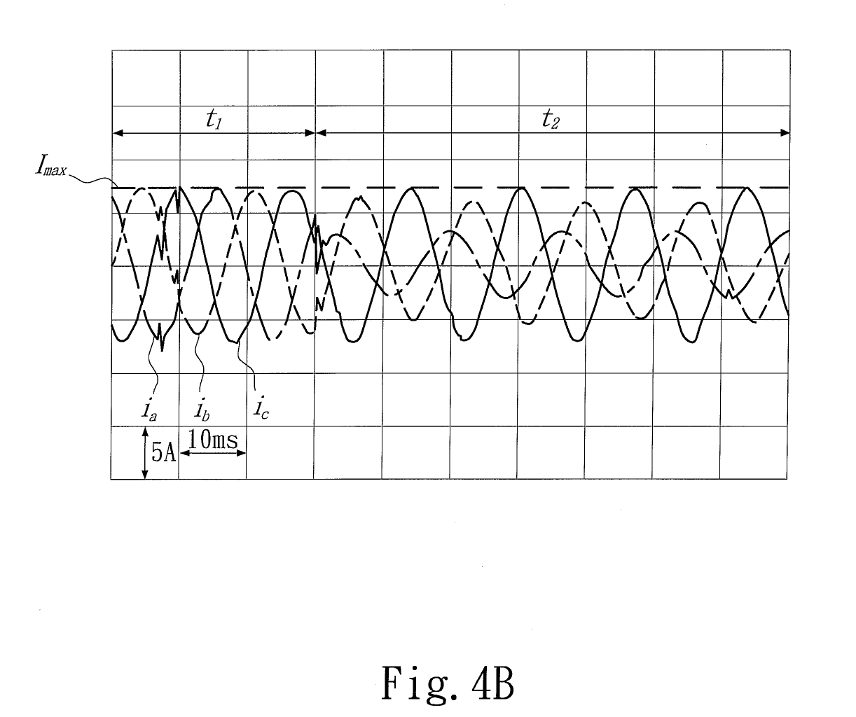

Refer to FIG. 4A. In a stable state, the three phase current components iₐ, i_{b} and i_{c} respectively have different intensity curves and respectively have their peak values at different phases. The power threshold Iₘₐₓ has to be set greater than any one of the peak values of the currents iₐ, i_{b} and i_{c}. In a practical circuit design, the power threshold Iₘₐₓ that the IGBT 11 can withstand is constant. After the power threshold is obtained, any one of the peak values of the currents iₐ, i_{b} and i_{c} cannot exceed the power threshold Iₘₐₓ. When voltage drops abruptly or outage occurs, the power generation system has to output stable active power current and reactive power current. Refer to FIG. 4B. In the normal output period t₁, all of the currents iₐ, i_{b} and i_{c} are smaller than the power threshold Iₘₐₓ. In the LVRT period t₂, the currents iₐ, i_{b} and i_{c} drop abruptly. The currents have to be compensated to supply stable active power current and reactive power current and the compensation currents are still set not greater than the power threshold Iₘₐₓ. The present invention manipulates the negative sequence electrical component to control the reactive power current to achieve stable output. It should be further explained herein that when the positive sequence electrical component is boosted, the negative sequence reactive power compensation signal is used to reduce the negative sequence electrical component output by the grid-connected converter 10 so as to balance the output power to the power network 30 to achieve stable output.

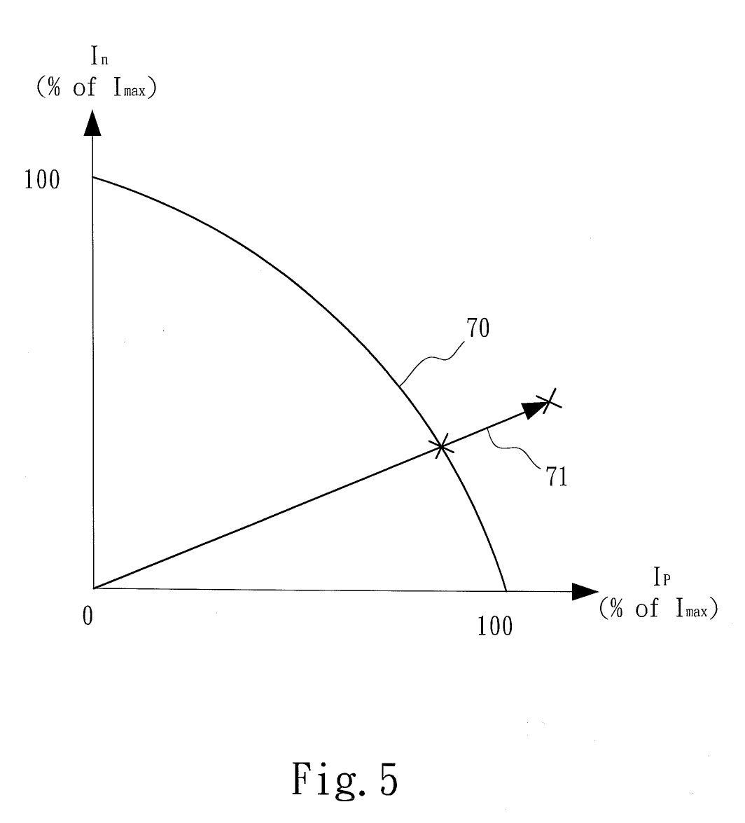

Refer to FIG. 5. The present invention regulates the active power and the reactive power via regulating the positive sequence current and the negative sequence current. The ratio of the positive sequence current and the negative sequence current is determined according to the specified system design, whereby to reduce the low frequency ripple. As shown in FIG. 5, the low-ripple selection line 71 and the power threshold output curve 70 intersect at a point, which determines the values of Iₚ and Iₙ. Thus is decreased the number or the total capacitance of the capacitors for reducing the low frequency ripple. Therefore, the circuit volume and the fabrication cost are also decreased.

In conclusion, the present invention uses the negative sequence electrical component to undertake the reactive power compensation. Especially, the present invention undertakes the negative sequence inductive reactive power current compensation to control the negative sequence electrical component and regulate the reactive power voltage, whereby is enhanced balance and stability of voltage in the LVRT period, and whereby is avoided reverse torque and mechanical resonance, and whereby is prolonged the service life of the power generator. Further, the present invention undertakes the positive sequence electrical component compensation to regulate the positive sequence active and reactive powers, and constrains the sum of the compensation currents below the power threshold to prevent the circuit of the power generator from being overloaded and damaged, whereby is prolonged the service life of the power system. Furthermore, the circuit system of the present invention itself can eliminate ripple without using extra elements (such as capacitors) of the external circuit. Therefore, the present invention can greatly decrease the complexity of the system and effectively reduce the fabrication cost.

What is claimed is:

1. A low voltage ride-through control method for a grid-connected converter of distributed energy resources, wherein a grid-connected converter supplies an output power to a power network connecting with the grid-connected converter, and wherein the low voltage ride-through control method comprises steps of:
Step S1: using a processor to capture the output power to obtain a positive sequence electrical component and a negative sequence electrical component when the output power drops abnormally;
Step S2: the processor working out a negative sequence reactive power compensation signal according to the positive sequence electrical component, the negative sequence electrical component and a power threshold withstood by the grid-connected converter, and outputting the negative sequence reactive power compensation signal to a regulation unit controlling the grid-connected converter; and
Step S3: the regulation unit compensating the negative sequence electrical component output by the grid-connected converter according to the negative sequence reactive power compensation signal, and constraining a sum of the positive sequence electrical component and the compensated negative sequence electrical component not higher than the power threshold.

2. The low voltage ride-through control method according to claim 1, wherein Step S2 further comprises steps of:
Step S2A: defining a first function correlating with the positive sequence electrical component and a second function correlating with the negative sequence electrical component, and obtaining a relationship function of the power threshold and the first and second functions;
Step S2B: substituting a rated positive sequence electrical component into the first function, and using the power threshold to obtain a target negative sequence electrical component; and
Step S2C: comparing the target negative sequence electrical component with the negative sequence electrical component to obtain the negative sequence reactive power compensation signal and undertake signal compensation.

3. The low voltage ride-through control method according to claim 1, wherein the positive sequence electrical component and the negative sequence electrical component are currents.

4. The low voltage ride-through control method according to claim 1, wherein the positive sequence electrical component includes a positive sequence active power current and a positive sequence reactive power current.

5. The low voltage ride-through control method according to claim 1, wherein the negative sequence electrical component includes a negative sequence reactive power current.

6. The low voltage ride-through control method according to claim 1, wherein in Step S2, the processor outputs a positive sequence compensation signal to the regulation unit according to the power threshold withstood by the grid-connected converter.

7. The low voltage ride-through control method according to claim 6, wherein in Step S3, the processor outputs the positive sequence compensation signal to the regulation unit, and wherein the regulation unit regulates the positive sequence electrical component output by the grid-connected converter to undertake positive sequence active power and positive sequence reactive power compensation.

8. The low voltage ride-through control method according to claim 7, wherein when the positive sequence electrical component is boosted, the negative sequence reactive power compensation signal is used to reduce the negative sequence electrical component output by the grid-connected converter so as to balance the output power to the power network.

9. The low voltage ride-through control method according to claim 1, wherein the power threshold is determined by an upper power limit withstood by an insulated gate bipolar transistor arranged inside the grid-connected converter.
